(19) United States
(12) Patent Application Publication
(10) Pub. No.: US 2013/0238552 A1
(43) Pub. Date: Sep. 12, 2013

(54) SYSTEMS AND METHODS FOR SYNCHRONIZING FILES IN A NETWORKED COMMUNICATION SYSTEM

(71) Applicant: Joseph SAIB, Santa Clara, CA (US)

(72) Inventor: Joseph SAIB, Santa Clara, CA (US)

(21) Appl. No.: 13/418,090

(22) Filed: Mar. 12, 2012

(51) Int. Cl. G06F 17/30

(52) U.S. Cl. 707/609; 707/E17.005; 707/E17.01

(57) ABSTRACT

Systems and methods are provided for synchronizing files in a networked communication system. A server can receive a file or a notification of an update to a file from a client and/or remote storage medium. In response, the server can determine whether the received file is the most recent version of the file. The server can compare the timestamp of the received file with the timestamp of the file currently stored as the most recent version of the file. If the received file is the most recent version of the file, the server stored the received file as the most recent version of the file.

### BACKGROUND

1. Technical Field

Disclosed systems and methods relate to synchronizing files in a networked communication system.

2. Description of the Related Art

Traditionally, computing devices managed data files locally. For example, a computer stored data files on a local storage medium and accessed the contents of the data files by retrieving them from the local storage medium. Oftentimes, the local storage medium could only be accessed by the computing device being physically coupled to the storage medium. Therefore, the management of data files on a local storage medium was largely independent of other computing devices. Such a local data file management had some benefits. One benefit was the speed at which data files could be stored and accessed. Another benefit was the ability to maintain the most recent version of the data files in the local storage medium.

However, the local management of data files rendered certain data management tasks cumbersome, especially the sharing of data files amongst multiple computing devices. For example, every time a user wanted to provide a data file to another computer, the user had to copy the data file into a portable storage medium, such as a portable hard disk or a Universal Serial Bus (USB) drive, and copy the data file in the portable storage medium to the destination computing device. In addition, if a user updated a data file on one computer or portable storage medium, this would create different versions of the data file across different computers and/or portable storage medium. The user would then have to keep track of the computer or portable storage medium with the most recent version of the data file so that the user did not inadvertently access an older version of the data file stored on a different computer or portable storage medium. Because this mechanism involves a physical coupling of the portable storage medium to the destination computing device, sharing of data files was slow, involved too much user interaction, created different versions of data files stored at different computers and/or portable storage medium, and was at best cumbersome.

Some of these issues have been addressed with communication networks. Communication networks enable server/client systems to share data files amongst multiple computing devices. A server/client data sharing system allows clients, such as computers, to locally access data files, just as in traditional computing devices. However, a server/client data sharing system also allows clients to access data files at a remote server via communication networks. Such a remote data access allows users to store data files at a remote server and access those files from any clients that are coupled to the remote server. Existing implementations of server/client data sharing systems include web-folder services, such as DROPBOX, INC., a Network File System (NFS,) or an Andrew File System (AFS.)

With existing server/client systems, the servers typically have their own storage. Data files from any client are sent through the server for storage. This allow for the server to be able to maintain master versions (or most recent versions) of the data files received from any client. Any time a client sends an updated data file to the server, the server stores the updated data file as the most recent version of the data file. The server will then notify all of the clients of the updated data file. Then, when the server receives a request for the data file from a client, the server will send the most recent version of the data file (or updated data file) to the client.

With the advances in network communications, including the introduction of cloud computing, data files can be stored at one or more remote storage locations other than at the server. Because data files can be stored at locations other than at the server, the server may not receive all data files from all clients for storage. A client can send an updated data file to a remote storage location without the server's knowledge. Existing servers are not necessarily informed of updated data files from the remote storage locations. As a result, existing servers do not always know when the data file that it accesses is the most recent version of the data file.

Therefore, there is a need in the art to provide systems and methods for improving the synchronization of files in a networked communication system. Accordingly, it is desirable to provide methods and systems that overcome these and other deficiencies of the related art.

### SUMMARY

In accordance with the disclosed subject matter, systems and methods are provided for synchronizing files in a networked communication system.

Disclosed subject matter includes a non-transitory computer readable medium having executable instructions. The executable instructions are operable to cause a server to store a file received from a client over a communication network in a storage medium, wherein the file is stored as a master version and has associated with it a first timestamp; receive a notification of an update to the file, wherein the notification has associated with it a second timestamp for the updated file; and compare the first timestamp to the second timestamp. When the second timestamp is later than the first timestamp, the executable instructions are further operable to cause the server to send a request for the updated file; and receive and store the updated file in the storage medium, wherein the updated file is stored as the master version.

Disclosed subject matter includes an apparatus comprising one or more interfaces configured to provide communication with a client via a communication network; and a processor, in communication with the one or more interfaces, and configured to run a module stored in memory. The module is configured to store a file received from a client over a communication network in a storage medium, wherein the file is stored as a master version and has associated with it a first timestamp; to receive a notification of an update to the file, wherein the notification has associated with it a second timestamp for the updated file; and to compare the first timestamp to the second timestamp. When the second timestamp is later than the first timestamp, the module is further configured to send a request for the updated file; and to receive and store the updated file in the storage medium, wherein the updated file is stored as the master version.

Disclosed subject matter includes a method comprising storing a file received from a client over a communication network in a storage medium, wherein the file is stored as a master version and has associated with it a first timestamp; receiving a notification of an update to the file, wherein the notification has associated with it a second timestamp for the updated file; and comparing the first timestamp to the second timestamp. When the second timestamp is later than the first timestamp, the method also comprises sending a request for the updated file; and receiving and storing the updated file in the storage medium, wherein the updated file is stored as the master version.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system.

FIG. 2 illustrates a diagram of a networked communication system in accordance with an embodiment of the disclosed subject matter.

FIG. 3 illustrates a flow diagram illustrating how the server synchronizes files in a networked computer system in accordance with certain embodiments of the disclosed subject matter.

FIG. 4 illustrates a flow diagram illustrating how the server synchronizes files in a networked computer system in accordance with certain embodiments of the disclosed subject matter.

FIG. 5 illustrates a flow diagram illustrating how the server synchronizes files in a networked computer system in accordance with certain embodiments of the disclosed subject matter.

FIG. 6 illustrates a flow diagram illustrating how the server synchronizes files in a networked computer system in accordance with certain embodiments of the disclosed subject matter.

FIG. 7 illustrates a block diagram of a server in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems and methods for providing synchronization of data files in a networked computer system. The clients in the networked computer system can store data files at one or more remote locations, including at a server and/or at one or more remote storage media apart from the server. The remote storage media can be in direct communication with the server or via a communication network. The data files can be any suitable files that include text, audio, video, images, or any other suitable data or combination of data.

In accordance with the disclosed subject matter, the server can receive one or more data files from any client and/or remote storage medium, within the same communication network or from other communication networks. In response, the server can determine whether the received data file is the most recent version of the data file. In particular, the server can determine whether the received data file has been updated and should now represent the master version of the data file that is stored remotely.

The server can compare the timestamp of the received data file to the timestamp of the most recent version of the data file that is currently stored at the server or other remote storage medium. The timestamp can represent the last date and time that the data file was updated, saved, and/or accessed. Although the disclosed subject matter is described in the context of comparing timestamps, any other suitable metric or combination of metrics can be used to determine the most recent version of the data file. In one embodiment, the server can send a request to its local storage or remote storage medium for the timestamp of the stored data file. In another embodiment, the server can send a request to its local storage or remote storage medium for the stored data file, and upon receiving the stored data file, can determine the timestamp. In yet another embodiment, the server can maintain a record of the timestamp of the stored data file.

When the timestamp of the received data file is more recent (e.g., a later date and time) than the timestamp of the stored data file, this indicates that the received data file is an updated version of the stored data file. Accordingly, the server can store the received data file at its local storage or remote storage medium. The server can now treat the received data file as the most recent version of the data file that is currently stored at the server or remote storage medium. In one embodiment, the server can replace the previously stored data file with the received data file so that only the most recent version of the data file is stored and can be accessed. In another embodiment, the server can store the received data file without replacing the previously stored data file so all versions of the data file are stored and can be accessed. Upon storing the received data file at its local storage or remote storage medium, the server can also update its record with the timestamp of the newly stored data file. The server can also send notifications to the clients and/or remote storage media notifying them of the updated data file.

When the timestamp of the received data file is less recent (e.g., an earlier date and time) than the timestamp of the stored data file, this indicates that the received data file is an older version of the stored data file. Accordingly, the server can ignore the received data file. Alternatively, the server can store the received file at its local storage or remote storage medium as an older version of the data file.

Also in accordance with the disclosed subject matter, the server can receive one or more notifications about updates to data files (rather than the data files themselves) from any client and/or remote storage medium, within the same communications network or from other communication networks. The notification can include any suitable information about the updated data file, including the timestamp of the updated data file. In response, the server can determine whether the updated data file is the most recent version of the data file, similar to that described above when the server receives the data files. If the updated data file is the most recent version of the data file, then the server can send a request to the client and/or remote storage medium for the updated data file. The server can store the updated data file at its local storage or remote storage medium and treat the updated data file as the most recent version of the data file that is currently stored at the server or remote storage medium.

In one embodiment, the server can automatically receive notifications about updates to data files, or the updated data files themselves, from any client and/or remote storage medium. In another embodiment, the server can periodically send requests to any client and/or remote storage medium for updates to data files. In yet another embodiment, a listener can be placed at any client and/or remote storage medium to monitor for updates to data files and in response, to send notifications of the updates or the updated data files themselves, to the server. The listener can be any suitable hardware, software, or a combination thereof.

The disclosed subject matter can achieve greater reliability by providing clock synchronization at any one or more of the client, server, and remote storage medium. In one embodiment, the internal clocks at each of these devices can be synchronized to a master clock and/or to one another. In another embodiment, the server can be provided with information about the clocks of any client and/or remote storage medium. This allows the server to take into account any changes in time with respect to the server clock when comparing timestamp information. The information about the clocks of any client and/or remote storage medium can be the delay between those clocks and the server clock, or any other suitable information. In yet another embodiment, the server can also keep a record of the history of any time drift between the clocks of any client and/or remote storage medium and the server. This allows the server to take into account any changes in time when comparing timestamp information. Providing clock synchronization ensures the accuracy of the timestamps for data files so that the data file with the most recent timestamp is stored as the most recent version of the data file. Clock synchronization can occur once, at periodic intervals, at random intervals, in response to a server receiving a data file, in response to a server receiving a notification of an update to a data file, or at any other suitable time or combination of times.

The disclosed subject matter can also achieve greater reliability by performing error control on the timestamps of data files. If a server receives a data file or a notification of an update to a data file having a timestamp at some future time or invalid time (e.g., a date of January 32, a time of 25:00), the server can change the timestamp associated with that data file and perform synchronization on the data file. Alternatively, the server can treat the data file or notification as invalid and decide not to perform synchronization on the data file. In addition, the server can also check the timestamps of the data files stored at its local storage and/or remote storage medium, and/or its record of timestamps of stored data files, and correct any timestamp set to some future time or invalid time.

The disclosed subject matter allows for a server to synchronize data files across different remote storage mediums so that any client accessing a remote data file stored at the server or other remote storage medium can receive the most recent version of the data file.

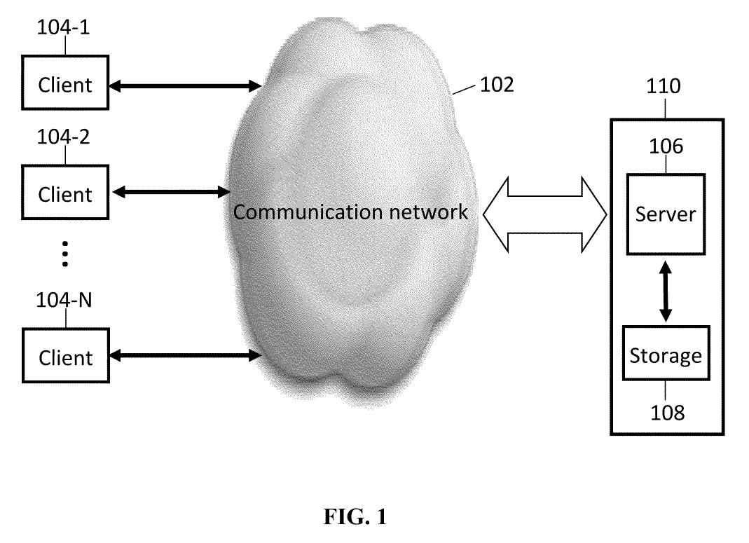

FIG. 1 illustrates a diagram of a networked communication system in accordance with existing systems. FIG. 1 includes a communication network 102, at least one client 104 (e.g., client 104-1, 104-2, . . . 104-N), and a server system 110. The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. Although FIG. 1 represents the network 102 as a single network, the network 102 can include multiple interconnected networks listed above. Each client 104 can include a desktop computer, a mobile computer, a tablet computer, a cellular device, or any other computing devices having a processor and memory. Each client 104 can communicate with the server system 110 via the communication network 102 to send and receive data files. The server system 110 includes a server 106 and its local storage medium 108 for storing the data files. Although FIG. 1 represents the server 106 and the storage medium 108 as separate components, the server 106 and storage medium 108 can be combined together. Although FIG. 1 represents the server system 110 as a single server system, the server system 110 can include more than one server and can be part of a cloud-computing platform.

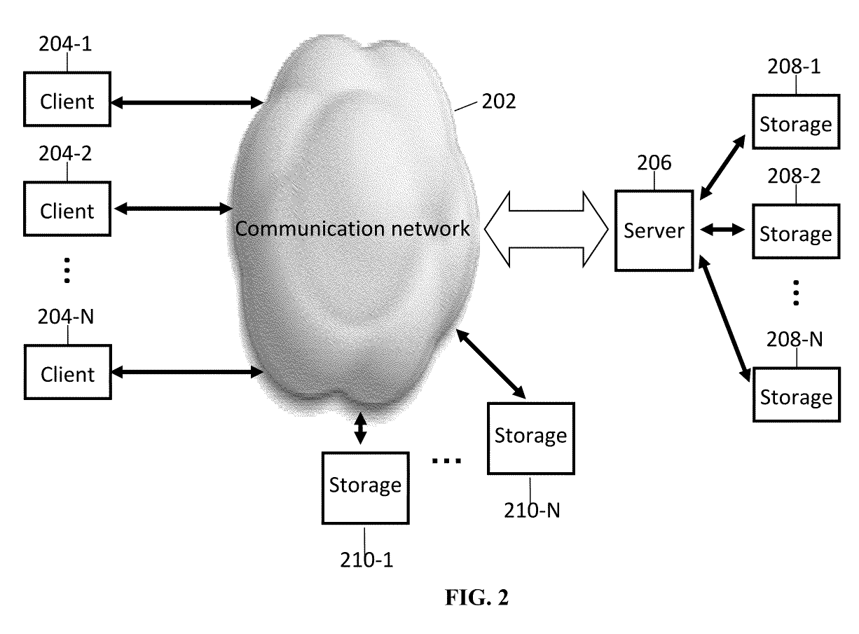

FIG. 2 illustrates a diagram of a networked communication system in accordance with an embodiment of the disclosed subject matter. FIG. 2 includes a communication network 202, at least one client 204 (e.g., client 204-1, 204-2, . . . 204-N), a server 206, and at least one remote storage medium (e.g., storage medium 208-1, 208-2, . . . 208-N, 210-1, . . . 210-N). The communication network 202 can be similar to communication network 102 (FIG. 1). Each client 204 can be similar to client 104 (FIG. 1). The server 206 can be similar to server system 106 (FIG. 1) and can have its own local storage medium combined with, or separate from, the server. There can be one or more remote storage media 208 that are coupled directly to server 206. There can also be one or more remote storage media 210 that are coupled to server 206 via communication network 202. Remote storage media 208 and/or 210 can be any suitable storage media including a physical database or cloud database. Each client 204 can communicate with the server 206 via the communication network 202 to send and receive data files. Data files can be stored at server 206, one or more of storage media 208, and/or one or more of storage media 210.

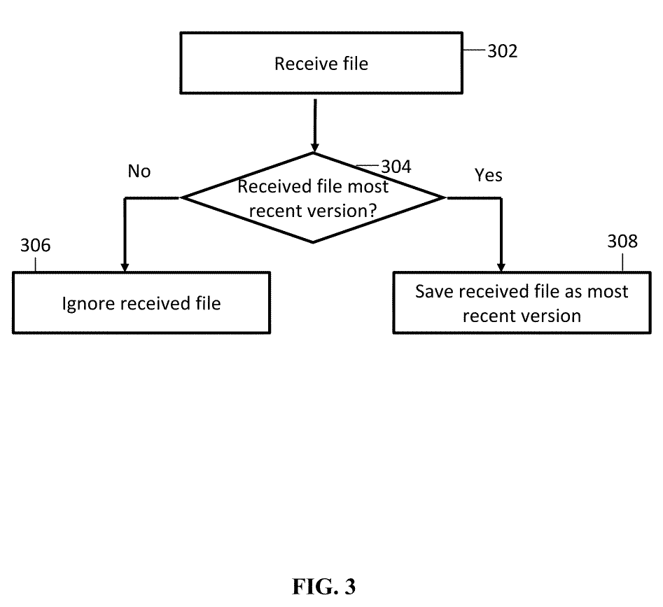

FIG. 3 illustrates a flow diagram illustrating how a server synchronizes files in a networked computer system in accordance with certain embodiments of the disclosed subject matter. At step 302, the server 206 receives a file from a client 204 or remote storage medium 208/210. At step 304, the server 206 determines whether the received file is the most recent version of the file. If the received file is not the most recent version of the file, server 206 ignores the received file at step 306. If the received file is the most recent version of the file, the server 206 saves the received file as the most recent version of the file at step 308. The server 206 can save the received file at its local storage medium and/or at one or more of the remote storage media 208/210.

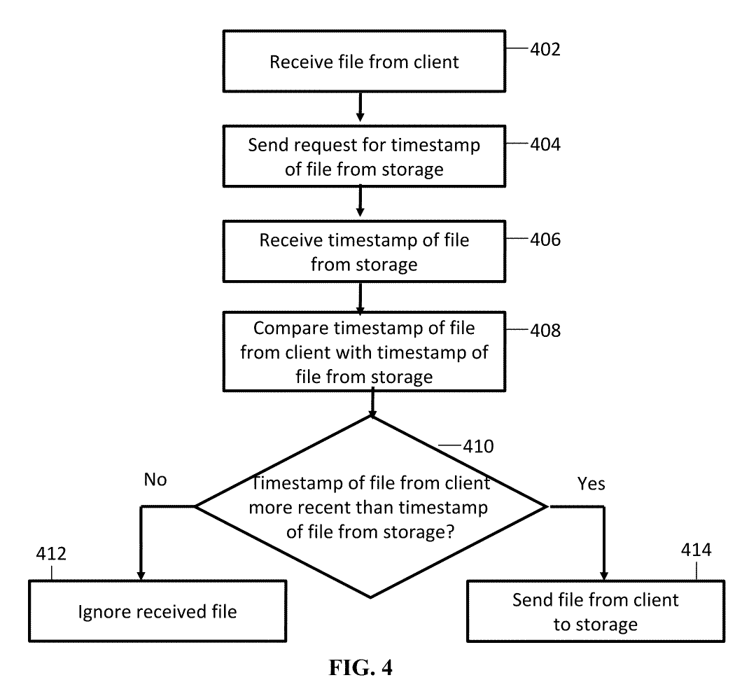

FIG. 4 illustrates a flow diagram illustrating how a server synchronizes files in a networked computer system in accordance with certain embodiments of the disclosed subject matter. At step 402, the server 206 receives a file from a client 204. The file can include information about the file, including a timestamp. The timestamp can represent the last date and time that the data file was updated, saved, and/or accessed.

At step 404, the server 206 sends a request for the timestamp of the file currently stored as the most recent version of the file. The most recent version of the file can be stored at the server 206's local storage medium and/or remote storage medium 208/210. The server 206 can send the request to its local storage medium and/or remote storage medium 208/210. The request can be formatted as an Extensible Markup Language (XML), Google Protobuf, Hypertext Transfer Protocol (HTTP), JavaScript Object Notation (JSON), or any other format suitable for data communication. In response, the server 206 receives the timestamp of the file currently stored as the most recent version of the file at step 406. The server 206 can receive just the timestamp, information describing the file that includes the timestamp, and/or the entire file from which the timestamp can be extracted. The server 206 can receive this information in the same format as, or a different format from, the request.

At step 408, the server 206 compares the timestamp of the received file with the timestamp of the file currently stored as the most recent version of the file. At step 410, the server 206 determines whether the timestamp of the received file is more recent than the timestamp of the file currently stored as the most recent version of the file. If the timestamp of the received file is older than the timestamp of the file currently stored as the most recent version of the file, server 206 ignores the received file at step 412.

If the timestamp of the received file is later than the timestamp of the file currently stored as the most recent version of the file, server 206 saves the received file as the most recent version of the file at step 414. The server 206 can save the received file at its local storage medium and/or at one or more of the remote storage media 208/210. Although FIG. 4 shows the server 206 as receiving the file from the client 204, the server 206 can also receive the file from the remote storage medium 208/210.

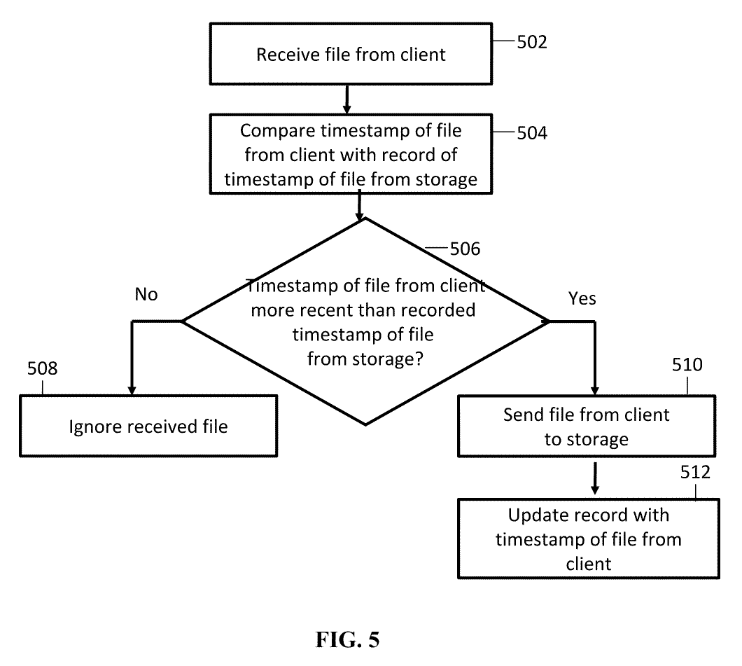

FIG. 5 illustrates a flow diagram illustrating how a server synchronizes files in a networked computer system in accordance with certain embodiments of the disclosed subject matter. At step 502, the server 206 receives a file from a client 204. The file can include information about the file, including a timestamp. The timestamp can represent the last date and time that the data file was updated, saved, and/or accessed.

At step 504, the server 206 compares the timestamp of the received file with a record of the timestamp of the file currently stored as the most recent version of the file. At step 506, the server 206 determines whether the timestamp of the received file is more recent than the recorded timestamp of the file currently stored as the most recent version of the file. If the timestamp of the received file is older than the timestamp of the file currently stored as the most recent version of the file, server 206 ignores the received file at step 508.

If the timestamp of the received file is later than the timestamp of the file currently stored as the most recent version of the file, server 206 saves the received file as the most recent version of the file at step 510. The server 206 can save the received file at its local storage medium and/or at one or more of the remote storage media 208/210. The server 206 also updates its record with the timestamp of the received file as the file currently stored as the most recent version of the file in step 512. Although steps 510 and 512 are shown as separate steps, they can be done in any order or at the same time. Although FIG. 5 shows the server 206 receiving the file from the client 204, the server 206 can also receive the file from the remote storage medium 208/210.

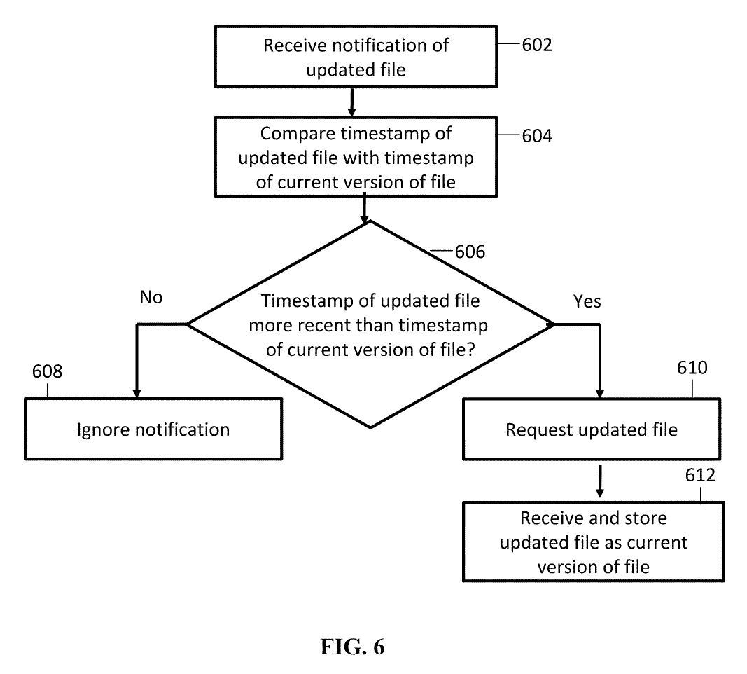

FIG. 6 illustrates a flow diagram illustrating how a server synchronizes files in a networked computer system in accordance with certain embodiments of the disclosed subject matter. At step 602, the server 206 receives a notification of an update to a file. The server 206 can receive the notification from a client 204 or from a remote storage medium 208/210. The notification can include any suitable information about an updated data file, including the timestamp of the updated data file. The timestamp can represent the last date and time that the data file was updated, saved, and/or accessed.

At step 604, the server 206 compares the timestamp of the updated file with the timestamp of the file currently stored as the most recent version of the file. The timestamp of the file currently stored as the most recent version of the file can be requested and received from the server 206's local storage medium and/or remote storage medium 208/210 (similar to steps 404 and 406 in FIG. 4). Alternatively, the timestamp of the file currently stored as the most recent version of the file can be the recorded timestamp locally stored at the server 206 (similar to step 504 in FIG. 5).

At step 606, the server 206 determines whether the timestamp of the updated file is more recent than the timestamp of the file currently stored as the most recent version of the file. If the timestamp of the received file is older than the timestamp of the file currently stored as the most recent version of the file, server 206 ignores the received file at step 608.

If the timestamp of the received file is later than the timestamp of the file currently stored as the most recent version of the file, server 206 requests the updated file from the client 204 or from the remote storage medium 208/210 at step 610. The request can be formatted as XML, Google Protobuf, HTTP, JSON, or any other formats suitable for data communication. Upon receiving the updated file, the server stores the updated file as the most recent version of the file at step 612. The server 206 can save the updated file at its local storage medium and/or at one or more of the remote storage media 208/210. The server 206 can also update its record with the timestamp of the updated file as the file currently stored as the most recent.

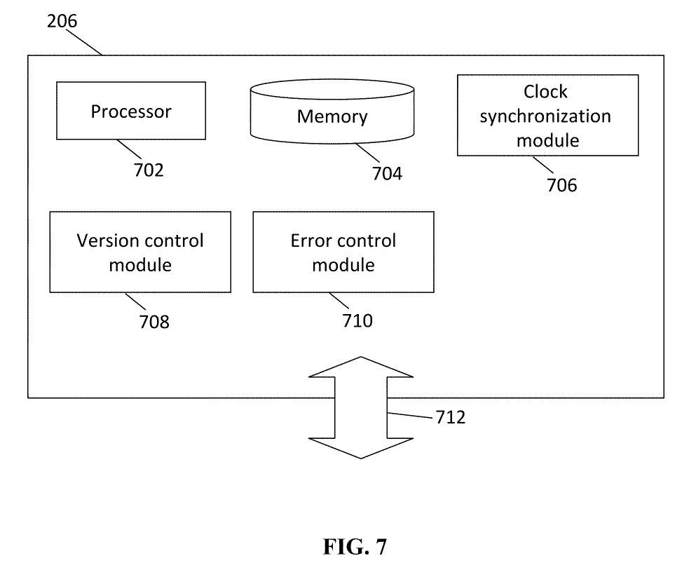

FIG. 7 illustrates a block diagram of a server in accordance with certain embodiments of the disclosed subject matter. The server 206 can include at least a processor 702, at least one memory 704, a clock synchronization module 706, a version control module 708, and an error control module 710.

A clock synchronization module 706 is configured to provide clock synchronization between the server 206 and one or more of the client 204 and/or remote storage medium 208/210. The clock synchronization module 706 can be configured to ensure the accuracy of the timestamps for files so that the file with the most recent timestamp is stored as the most recent version of the file. The clock synchronization module 706 can be configured to perform synchronization once, at periodic intervals, at random intervals, in response to the server 206 receiving a data file, in response to the server 206 receiving a notification of an update to a data file, or at any other suitable time or combination of times.

An error control module 710 is configured to perform error control on the timestamps of data files. The error control module 710 can be configured to check the timestamps of incoming files and/or stored files. The error control module 710 can be further configured to correct and/or reject those files having a timestamp that is set to a future time or invalid time.

A version control module 708 is configured to synchronize the files that it receives from one or more of the client 204 and/or remote storage medium 208/210 so that the most recent version of the file is always stored. The version control module 708 is further configured to perform the processing steps shown and described in connection with FIGS. 3-6. The version control module 708 can include a record of the timestamps for the data files stored at the server 206's local storage medium and/or remote storage media 208/210. The version control module 708 can communicate with the clock synchronization module 706 and the error control module 710 to ensure the accuracy of the timestamps that are being compared and of the data files being synchronized.

The clock synchronization module 706, the version control module 708, and the error control module 710 can be implemented in software, which may be stored in memory 704. FIG. 7 shows server 206 having separate modules 706, 708, and 710 that perform the above-described operations in accordance with certain embodiments of the disclosed subject matter. In other embodiments of the invention, server 206 can include additional modules, less modules, or any other suitable combination of modules that perform any suitable operation or combination of operations. The memory 704 can be a non-transitory computer readable medium, flash memory, a magnetic disk drive, an optical drive, a programmable read-only memory (PROM), a read-only memory (ROM), or any other memory or combination of memories. The software runs on a processor 702 capable of executing computer instructions or computer code. The processor 702 might also be implemented in hardware using an application specific integrated circuit (ASIC), programmable logic array (PLA), field programmable gate array (FPGA), or any other integrated circuit.

An interface 712 provides an input and/or output mechanism to communicate over a network. The interface 712 enables communication with clients 204, as well as other network nodes in the communication network 202. The interface 712 also enables communications with storage media 210 over the communication network 202 and with storage media 208. The interface 712 is implemented in hardware to send and receive signals in a variety of mediums, such as optical, copper, and wireless, and in a number of different protocols some of which may be non-transient.

The server 206 can be configured with one or more processors 702 that process instructions and run software that may be stored in the memory 704. The processor 702 also communicates with the memory and interfaces to communicate with other devices. The processor 702 can be any applicable processor such as a system-on-a-chip that combines a CPU, an application processor, and flash memory.

The server 206 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 206. A task can be a software process that performs a specific function related to system control or session processing. Three types of tasks operate within the server 206 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 206 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 206 by monitoring the various software and hardware components of the server 206. Recovery control task subsystem is responsible for executing a recovery action for failures that occur in the server 206 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 206 with an ability to set, retrieve, and receive notification of server configuration parameter changes and is responsible for storing configuration data for the applications running within the server 206. A resource management subsystem is responsible for assigning resources (e.g., processor and memory capabilities) to tasks and for monitoring the task's use of the resources.

In some embodiments, the server 206 can reside in a data center and form a node in a cloud computing infrastructure. The server 206 can also provide services on demand. A module hosting a client is capable of migrating from one server to another server seamlessly, without causing program faults or system breakdown. The server 206 on the cloud can be managed using a management system.

The client 204 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client 204 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A non-transitory computer readable medium having executable instructions operable to cause a server to:
store a file received from a client over a communication network in a storage medium, wherein the file is stored as a master version and has associated with it a first timestamp;
receive a notification of an update to the file, wherein the notification has associated with it a second timestamp for the updated file;
compare the first timestamp to the second timestamp; and
when the second timestamp is later than the first timestamp:
send a request for the updated file, and
receive and store the updated file in the storage medium, wherein the updated file is stored as the master version.

2. The computer readable medium of claim 1, further comprising executable instructions operable to cause the server to receive a request for the file from the client and to send the updated file to the client in response to the request.

3. The computer readable medium of claim 1, wherein the executable instructions operable to cause the server to compare the first timestamp to the second timestamp is further operable to cause the server to send a request to the storage medium for the first timestamp and to receive the first timestamp from the storage medium in response to the request.

4. The computer readable medium of claim 1, wherein the executable instructions operable to cause the server to compare the first timestamp to the second timestamp is further operable to cause the server to retrieve the first timestamp from a record of timestamps for all files stored in the storage medium.

5. The computer readable medium of claim 4, further comprising executable instructions operable to cause the server to update the record of timestamps by replacing first timestamp with the second timestamp for the updated file.

6. The computer readable medium of claim 1, wherein the first timestamp comprises a date and time when the file was last updated and the second timestamp comprises a data and time when the updated file was last updated.

7. An apparatus comprising:
one or more interfaces configured to provide communication with a client via a communication network; and
a processor, in communication with the one or more interfaces, and configured to run a module stored in memory that is configured:
to store a file received from a client over a communication network in a storage medium, wherein the file is stored as a master version and has associated with it a first timestamp;
to receive a notification of an update to the file, wherein the notification has associated with it a second timestamp for the updated file;
to compare the first timestamp to the second timestamp; and
when the second timestamp is later than the first timestamp:
to send a request for the updated file, and
to receive and store the updated file in the storage medium, wherein the updated file is stored as the master version.

8. The apparatus of claim 7, wherein the module is further configured to receive a request for the file from the client and to send the updated file to the client in response to the request.

9. The apparatus of claim 7, wherein the module is further configured to send a request to the storage medium for the first timestamp and to receive the first timestamp from the storage medium in response to the request.

10. The apparatus of claim 7, wherein the module is further configured to retrieve the first timestamp from a record of timestamps for all files stored in the storage medium, wherein the record of timestamps is stored in the memory.

11. The apparatus of claim 10, wherein the module is further configured to update the record of timestamps by replacing first timestamp with the second timestamp for the updated file.

12. The apparatus of claim 7, wherein the first timestamp comprises a date and time when the file was last updated and the second timestamp comprises a data and time when the updated file was last updated.

13. The apparatus of claim 7, wherein the module is further configured to receive the notification of the update to the file from, and to send the request for the updated file to, the client.

14. The apparatus of claim 7, wherein the module is further configured to receive the notification of the update to the file from, and to send the request for the updated file to, a second storage medium.

15. A method comprising:
storing a file received from a client over a communication network in a storage medium, wherein the file is stored as a master version and has associated with it a first timestamp;
receiving a notification of an update to the file, wherein the notification has associated with it a second timestamp for the updated file;
comparing the first timestamp to the second timestamp; and
when the second timestamp is later than the first timestamp:
sending a request for the updated file, and
receiving and storing the updated file in the storage medium, wherein the updated file is stored as the master version.

16. The method of claim 15, further comprising receiving a request for the file from the client and sending the updated file to the client in response to the request.

17. The method of claim 15, further comprising sending a request to the storage medium for the first timestamp and receiving the first timestamp from the storage medium in response to the request.

18. The method of claim 15, further comprising retrieving the first timestamp from a record of timestamps for all files stored in the storage medium.

19. The method of claim 18, further comprising updating the record of timestamps by replacing first timestamp with the second timestamp for the updated file.

20. The method of claim 15, wherein the first timestamp comprises a date and time when the file was last updated and the second timestamp comprises a data and time when the updated file was last updated.
